(19) United States
(12) Patent Application Publication
(10) Pub. No.: US 2026/0160427 A1
(43) Pub. Date: Jun. 11, 2026

(54) TRANSFORMABLE COOKING DEVICES AND METHODS FOR SAME

(71) Applicant: Chan Sourignavong, Lakeville, MN (US)

(72) Inventor: Chan Sourignavong, Lakeville, MN (US)

(21) Appl. No.: 19/318,860

(22) Filed: Sep. 4, 2025

Related U.S. Application Data
(60) Provisional application No. 63/690,667, filed on Sep. 4, 2024.

(51) Int. Cl. F24C 15/10; A47J 37/07

(52) U.S. Cl. CPC F24C 15/107; A47J 37/0713; A47J 2037/0795

(57) ABSTRACT

A transformable cooking device includes a cooking surface configured for coupling with a cooker having at least one heating element. The cooking surface includes a planar cooking face and a socketed cooking face is configured to support cookware having a curved surface. The socketed cooking face is opposed to the planar cooking face. The socketed cooking face includes a heating port extending through the cooking surface from the planar cooking surface through the socketed cooking face, and a support ring spaced from the heating port and surrounding the heating port. The support ring is configured to support the curved or bowl shaped surface of the cookware.

### PRIORITY

This application claims the benefit of priority to U.S. Provisional Patent Application Ser. No. 63/690,667, filed Sep. 4, 2024, which is incorporated by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Chan Sourignavong of Lakeville, MN. All Rights Reserved.

### TECHNICAL FIELD

This document pertains generally, but not by way of limitation, to cooking surfaces.

### BACKGROUND

Cooking surfaces provide heat for cooking of food. For instance foods are placed in cookware, such as pots, pans or the like and the cookware is placed on the cooking surface to cook the food. Heat is transferred from one or more heating elements to the cooking surface, and from the cooking surface to cookware and food in the cookware.

In some examples, for instance with a wok or similar cookware, a chef (e.g., cook, chef or the like) places food in the bowl of the wok. The chef manually places and maintains the wok in an upright position on the cooking surface. While cooking the food, the chef manipulates the wok while stirring the food, for instance with a spatula, spoon or the like.

### OVERVIEW

The present inventors have recognized, among other things, that a problem to be solved includes providing a supporting cook surface for different types of cookware that supports each type of cookware and permits direct application of heat to the cookware and food therein. For instance, a cook surface includes a support surface and cookware rests on the support surface. The support surface is, in some examples, planar (e.g., a planar cooking surface), and thereby is complementary to flat bottom cookware including pots, pans, skillets or the like. Heat is indirectly transferred from a heating element to the cooking surface, and from the cooking surface to the cookware resting on the cooking surface and food therein. In one example, the cook surface is a solid plate, such as glass, or is a grate including intervening metal (e.g., cast iron) struts that support cookware placed on the cook surface. A glass plate distributes heat across its surface including portions not in contact with the cookware, thereby decreasing heat transfer efficiency. Further, the portions of the glass plate in contact with the cookware interrupt direct heat transfer from a heating element to the cookware and, in some examples, decrease heat transfer efficiency. With grates having intervening struts, the struts interrupt the direct application of heat from a heating element to the cookware and also decrease heat transfer efficiency.

In still other example cook surfaces the planar cooking face is complementary to various cookware having complementary planar bottom surfaces. Other cookware, such as a wok, has a curved bottom surface and accordingly does not readily rest in an upright position on a cook surface having a planar bottom surface. Instead, the chef manually grasps a handle to ensure the wok remains in an upright orientation without tipping its contents on to the underlying cook surface.

In another example, a cook surface includes upstanding struts that extend across a curved bottom surface of a wok. The upstanding struts engage the wok curved bottom surface in the manner of a grate, for instance a grate having a curved profile. The grate and its upstanding struts with the curved profile engage the wok bottom surface and accordingly interrupt the direct transfer of heat from a heating element to the wok. Instead, the upstanding struts collect heat and distribute it into the remainder of the cook surface (e.g., surrounding portions of the grate). Further, the upstanding struts of the cook surface engage with and extend across the curved bottom surface of the wok. As a chef manually manipulates the wok (e.g., agitates, rotates, rocks, or the like) for stirring and thorough heating of the food therein the curved bottom surface rubs along the upstanding struts. The upstanding struts accumulate debris, grease, particulate or the like, and relative movement between the wok and the upstanding struts abrades the wok. Abrasion wears through surface coatings of the wok, and permits one or more of corrosion, rusting, wear or the like of the wok.

The present subject matter can help provide a solution to these problems, such as with a transformable cooking device having a cooking surface that is convertible between a planar cooking configuration and a socketed cooking configuration. The transformable cooking device includes a planar cooking face and an opposed socketed cooking face. The socketed cooking face includes a heating port extending through the cooking surface, for instance a continuous heating port that extends between the planar cooking face and the socketed cooking face. One or more support rings surround the heating port. The one or more support rings remotely engage cookware positioned on the rings relative to the heating port. The remote engagement of the cookware decreases interruption of the direct application of heat from a heating element of a cooker to the cookware positioned on the support rings. Accordingly, direct and efficient heat transfer is achieved from the heating element to the cookware and food therein. Additionally, the one or more support rings cup and support the cookware in the manner of a bowl or ring and thereby distribute the weight of the cookware along the rings. The distribution of weight decreases friction between the cookware and the cooking surface and thereby decreases abrasion of the cookware that otherwise may cause early corrosion or rusting of cookware caused by abrasion from upstanding struts.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1A is a perspective view of one example of a cooker.

FIG. 1B is an exploded view of the cooker of FIG. 1A with an example of a transformable cooking surface.

FIG. 2 is an exploded view of the cooker of FIG. 1A with the transformable cooking surface of FIG. 1B.

FIG. 3 is a perspective view of the transformable cooking surface of FIG. 1B.

FIG. 4 is a top view of the transformable cooking surface of FIG. 3.

FIG. 5 is a side view of the transformable cooking surface of FIG. 3.

FIG. 6A is a side view of the transformable cooking surface of FIG. 3 in a planar cooking configuration with a cooker.

FIG. 6B is a side view of the transformable cooking surface of FIG. 3 in a socketed cooking configuration with the cooker.

### DETAILED DESCRIPTION

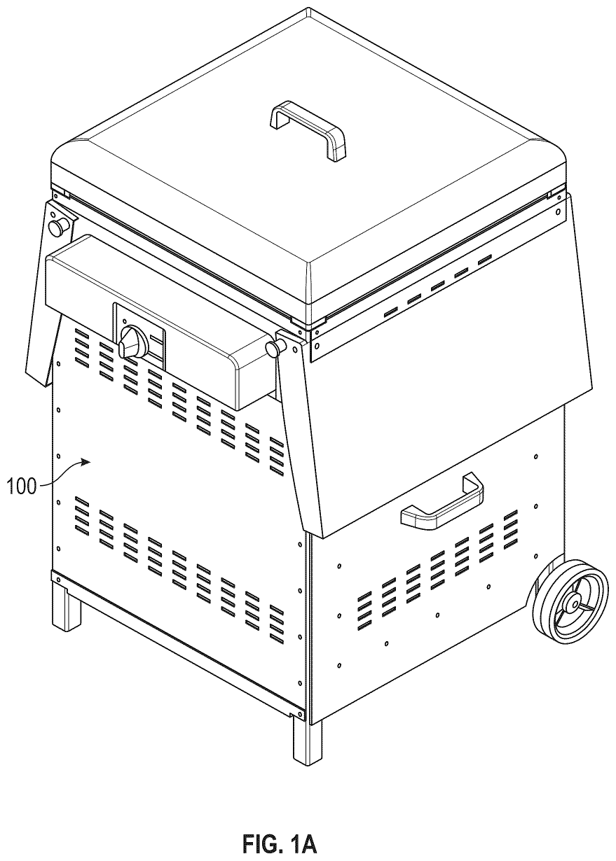

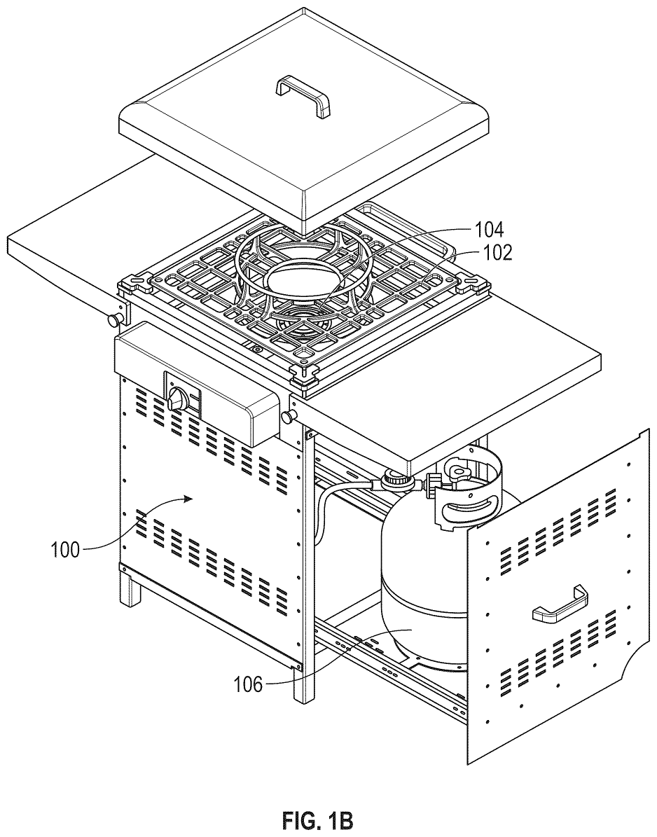

FIGS. 1A and 1B show one example of a cooker 100. The cooker 100 includes, as shown in FIG. 1B, a heating element 104 and an energy source 106, such as a propane or kerosene tank. In an example a transformable cooking surface 102 is coupled with the remainder of the cooker 100. Optionally, the transformable cooking surface 102 is provided with the cooker 100. In another example, the transformable cooking surface 102 is provided as a standalone device. As will be described herein the transformable cooking surface 102 is reconfigurable and includes at least two opposed surfaces providing different complementary profiles to support or couple with different cookware.

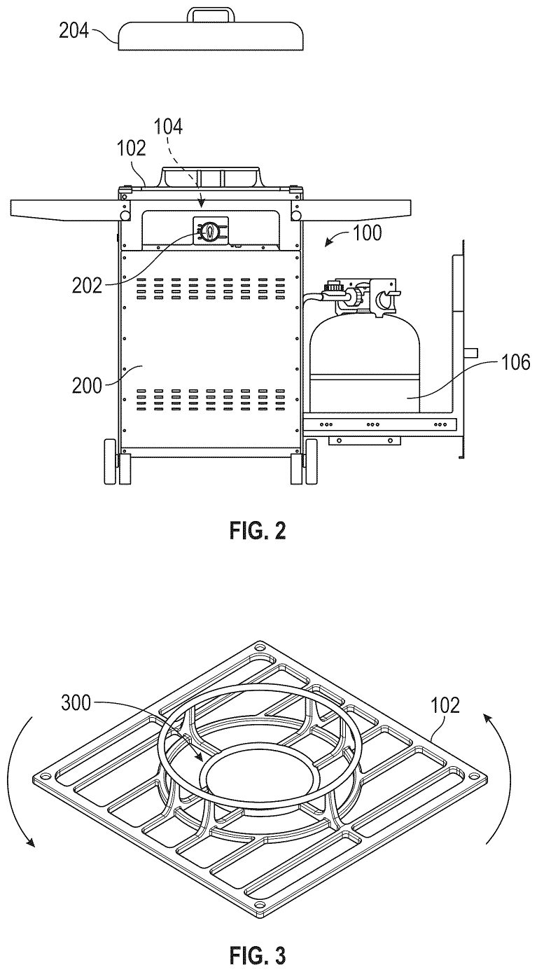

FIG. 2 shows another example of the cooker 100 including the transformable cooking surface 102 provided in a socketed cooking surface configuration. As shown in FIG. 2, the cooker 100 includes a cooker body 200, and a fuel tank 106 is provided in an operable drawer to facilitate positioning of the fuel tank 106 within the cooker body 200. As further shown in FIG. 2A, a heating element control 202 is provided with the cooker 104 to control the heating element 104. Optionally, a lid 204 removably coupled with the remainder of the cooker 100 to permit covering of the transformable cooking surface 102, the heating element 104, or the like.

In one example the cooker 100 is provided in a deployed configuration such as that shown in FIGS. 1B, 2 with example side tables unfolded and the cooker 100 is ready to use, for instance with the transformable cooking surface 102. In another example, the cooker 100 configured to a stowed configuration such as that shown in FIG. 1A, for instance with one or more side tables folded along the remainder of the cooker body 200 and the lid 204 coupled over top of the transformable cooking surface 102 and the heating element 104.

FIG. 3 shows the transformable cooking surface 102 in a standalone configuration. As shown in FIG. 3 the transformable cooking surface 102 includes a cookware socket 300. As described herein the cookware socket 301 in one example has a complimentary profile, such as a ring profile, bowl profile or the like (collectively ring profile) configured to engage with and support complimentary cookware positioned on the transformable cooking surface 102. As Further shown in FIG. 3 with the directional arrows the transformable cooking surface 102 is repositionable or transformable to either of a planar cooking configuration or a socketed cooking configuration. In the socketed cooking configuration the cookware socket 300 is in an upright position, such as that shown in FIG. 3. In the socketed cooking configuration the socketed cooking face of the transformable cooking surface 102 is configured for complimentary receipt, support or the like (e.g., collectively receipt) of cookware. For instance, the cookware socket 300 provides a supporting profile that receives and supports skillets, pans, pots, woks, or the like having a curved or bowl shaped profile.

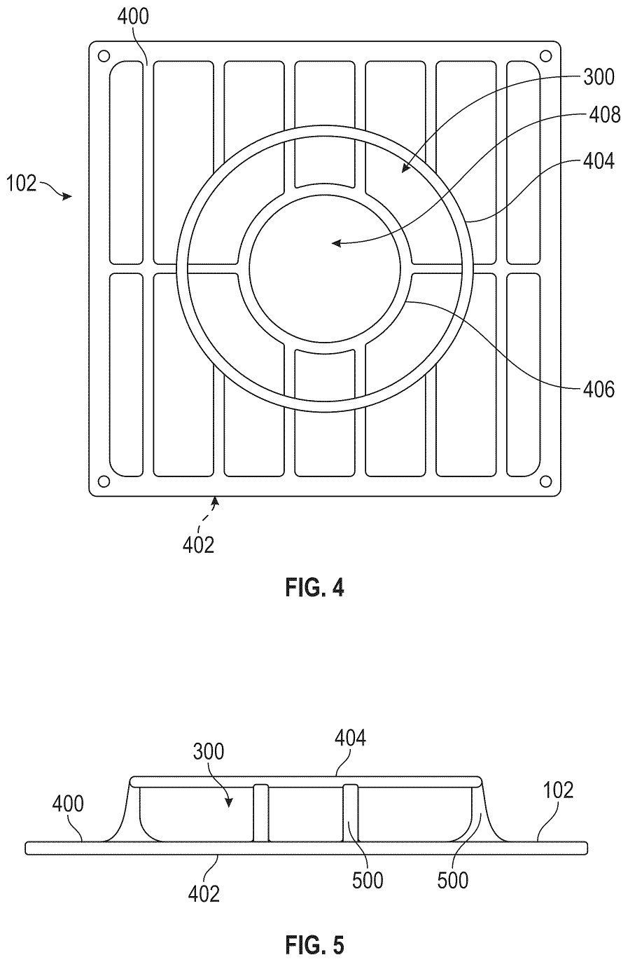

Referring now to FIG. 4, the socketed cooking face 400 (also referred to as a first cooking face) is shown in an upright position relative to an underlying planar cooking face 402. The socketed cooking face 400 includes the cookware socket 300 previously shown in FIG. 3. The cookware socket 300 is provided with one or more support rings 404, 406, for instance a first support ring 404, a second support ring 406 spaced from the first support ring 404, or the like. In one example, the first and second support rings 404, 406 (alone or together) provide a complementary profile to one or more items of cookware including, but not limited, to a bowl, skillet, wok or the like having a curved or bowl shaped surface (e.g., collectively curved). The first and second support rings 404, 406 accordingly engaged with support the one or more items of cookware to permit manipulation and support relative to the socketed cooking surface 400.

The portable cooking surface 102 in another example includes a heating port 408. The heating port 408 extends through cookware socket 300 and each of the one or more rings 404, 406, for instance in an unobstructed manner. In another example, the transformable cooking surface 102 includes a single support ring such as the first support ring 404 and the heating port 408 extends through the support ring 404 (and cookware socket 300). The cookware socket 300, including the one or more support rings 404, 406, permit direct heating of cookware positioned within the cookware socket 300. For instance open flame and associated heat are directed through the heating port 408 and directly contact the cookware supported on the socketed cooking surface 400. In this example the transformable cooking surface 102 does not include interrupting struts, flanges, or the like. Instead these features are absent (e.g., remotely positioned relative to the heating element) because one or more of the surrounding support rings 404, 406 or the like locate and support the cookware in a remote fashion relative to the heating port 408. In one example the heating port 408 extends between one or more surfaces or sides of the first support ring 404 (e.g., segments of the support ring). In another example, the heating port 408 extends between one or more sides of the second support ring 406 (e.g., segments of the support ring) and thereby provides an orifice through the transformable cooking surface 102 that permits direct heating of cookware received in the cookware socket 300. Referring now to FIG. 5, the transformable cooking surface 102 is shown in a side view. In this example the socketed cooking face 400 is shown in an upright position while the planar cooking face 402 is in a downward facing direction. In some examples, this orientation is referred to as the socketed cooking configuration. In another example, the planar cooking face 402 is inverted (e.g., upright) and in this planar cooking configuration the planar cooking face 402 provides a planar cooking surface for coupling with cookware such as pans, skillets or the like.

As further shown in FIG. 5, the transformable cooking surface 102 in various examples includes one or more support struts 500 extending from a portion of the transformable cooking surface 102 such as the planar cooking face 402 to one or more of the first support ring 404 or the second support ring 406. The support struts 500 are remotely positioned from the heating port 408 previously described herein. Accordingly, the support struts 500 are absent from the heating port 408 and direct, uninterrupted, heating of cookware positioned within the cookware socket 300 is permitted. In another example, the support struts 500 are absent from the heating port 408 and thereby permit direct heating of the cookware in the cookware socket 300 through the transformable cooking surface 102.

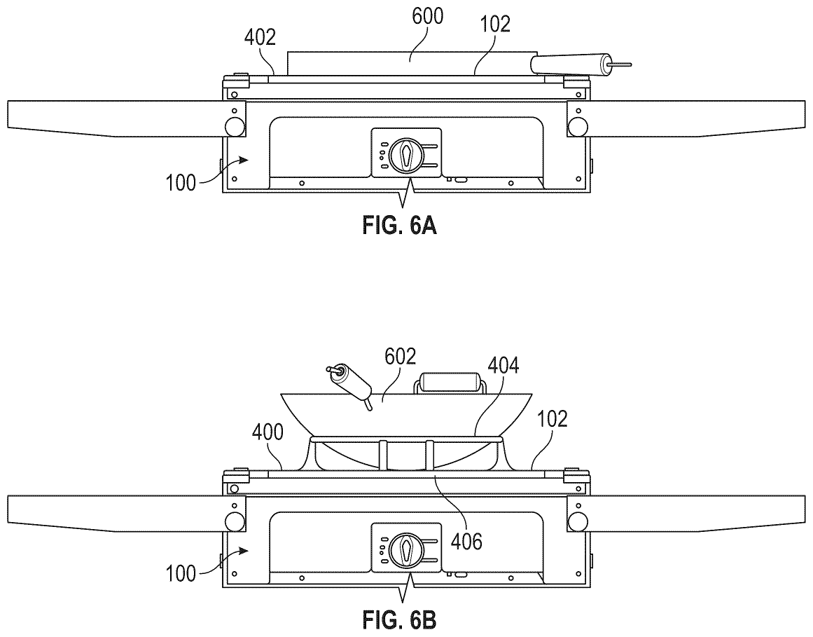

In FIG. 6A, the transformable cooking surface 102 is in the planar cooking configuration. For instance, the planar cooking face 402 upright relative to the previous Figures. In this example an item of cookware, such as a skillet, pan, pot or the like having a planar is coupled along the plantar cooking face 402. The heating port 408 remains open in the planar cooking configuration (like the socketed cooking configuration). For instance, the underlying first or second support rings 404, 406 are remote relative to the heating port 408 and accordingly the cookware is directly heated with an open flame, other heating element, or the like through the heating port 408.

Referring now to FIG. 6B, the transformable cooking surface 102 is shown in the socketed cooking configuration. For instance, the socketed cooking face 400 is upright and thereby inverted relative to FIG. 6A. In this example an item of cookware 602 is received within the cookware socket 300 (see FIGS. 4 and 5) and supported with the one or more support rings 404, 406. In one example, the cookware 602 is coupled (including slidably coupled) with one or both of the first support ring 404 or the second support ring 406. Accordingly, operators such as a cook or the like, are able to manipulate the cookware 602 for instance with an accompanying handle while maintaining the cookware 602 within the cookware socket along the socketed cooking face 400. In another example, the first and second support rings 404, 406 and the associated cookware socket 300 position the cookware 602 in a relatively aligned position relative to the heating port 408 and the heating element 104 (previously shown in FIGS. 1B, 2).

In another example the one or more first or second support rings 404, 406 provide a continuous surface, feature, or element of the cookware socket 300 that facilitates slidable coupling between the cookware 602 and the socketed cooking face 400. Accordingly, sharp edges, abrasive features, corners, or the like are decreased relative to cooking surfaces with exposed support struts or flanged. The support rings 404, 406 thereby facilitate the maintenance of surface finishes, coatings, or the like of the cookware 602 while decreasing scratching, abrasion, or the like.

### Various Notes

Aspect 1 can include subject matter such as a transformable cooking device includes: a cooking surface configured for coupling with a cooker having at least one heating element, the cooking surface includes: a planar cooking face; and a socketed cooking face configured to support cookware having a curved surface, the socketed cooking face opposed to the planar cooking face; and wherein the socketed cooking face includes: a heating port extending through the cooking surface from the planar cooking surface through the socketed cooking face; and a support ring spaced from the heating port and surrounding the heating port, the support ring configured to support the curved surface of the cookware.

Aspect 2 can include, or can optionally be combined with the subject matter of Aspect 1, to optionally include wherein the heating port extends continuously across the ring.

Aspect 3 can include, or can optionally be combined with the subject matter of one or any combination of Aspects 1 or 2 to optionally include wherein the support ring extends around the heating port.

Aspect 4 can include, or can optionally be combined with the subject matter of one or any combination of Aspects 1-3 to optionally include wherein the support ring is elevated relative to a remainder of the socketed cooking face.

Aspect 5 can include, or can optionally be combined with the subject matter of one or any combination of Aspects 1-4 to optionally include wherein the support ring is interconnected with the cooking surface with one or more support struts.

Aspect 6 can include, or can optionally be combined with the subject matter of Aspects 1-5 to optionally include wherein the support ring includes a first support ring and a second support ring, and the first support ring is larger than the second support ring.

Aspect 7 can include, or can optionally be combined with the subject matter of Aspects 1-6 to optionally include wherein the first support ring is elevated relative to the second support ring.

Aspect 8 can include, or can optionally be combined with the subject matter of Aspects 1-7 to optionally include the cooker having the at least one heating element.

Aspect 9 can include, or can optionally be combined with the subject matter of Aspects 1-8 to optionally include wherein the cooking surface is transformable between a planar cooking configuration and a socketed cooking configuration: in the planar cooking configuration the planar cooking face is upstanding and configured to engage cookware having a planar surface; and in the socketed cooking configuration the socketed cooking face is upstanding and configured to engage cookware with a ring profile of the support ring complementary to cookware having the curved surface.

Aspect 10 can include, or can optionally be combined with the subject matter of Aspects 1-9 to optionally include a transformable cooking device includes: a cooking surface configured for coupling with a cooker having at least one heating element, the cooking surface includes: a planar cooking face; and a socketed cooking face configured to support cookware having a bowl shaped surface, the socketed cooking face opposed to the planar cooking face; wherein the socketed cooking face includes: a heating port extending through the cooking surface from the planar cooking surface through the socketed cooking face; and a support ring spaced from the heating port and surrounding the heating port, the support ring configured to support the bowl shaped surface of the cookware; and wherein the cooking surface is transformable between a planar cooking configuration and a socketed cooking configuration: in the planar cooking configuration the planar cooking face is upstanding and configured to engage cookware; and in the socketed cooking configuration the socketed cooking face is upstanding and the support ring supports the cookware having the bowl shaped surface with a ring profile complementary to the bowl shaped surface.

Aspect 11 can include, or can optionally be combined with the subject matter of Aspects 1-10 to optionally include wherein the heating port extends continuously across the ring.

Aspect 12 can include, or can optionally be combined with the subject matter of Aspects 1-11 to optionally include wherein the support ring extends around the heating port.

Aspect 13 can include, or can optionally be combined with the subject matter of Aspects 1-12 to optionally include wherein the support ring is elevated relative to a remainder of the socketed cooking face.

Aspect 14 can include, or can optionally be combined with the subject matter of Aspects 1-13 to optionally include wherein the support ring is interconnected with the cooking surface with one or more support struts spaced from the heating port.

Aspect 15 can include, or can optionally be combined with the subject matter of Aspects 1-14 to optionally include wherein the support ring includes a first support ring and a second support ring, and the first support ring is larger than the second support ring.

Aspect 16 can include, or can optionally be combined with the subject matter of Aspects 1-15 to optionally include wherein the first support ring is elevated relative to the second support ring.

Aspect 17 can include, or can optionally be combined with the subject matter of Aspects 1-16 to optionally include the cooker having the at least one heating element.

Each of these non-limiting aspects can stand on its own, or can be combined in various permutations or combinations with one or more of the other aspects.

The above description includes references to the accompanying drawings, which form a part of the detailed description. The drawings show, by way of illustration, specific embodiments in which the invention can be practiced. These embodiments are also referred to herein as “aspects” or “examples.” Such aspects or example can include elements in addition to those shown or described. However, the present inventors also contemplate aspects or examples in which only those elements shown or described are provided. Moreover, the present inventors also contemplate aspects or examples using any combination or permutation of those elements shown or described (or one or more features thereof), either with respect to a particular aspects or examples (or one or more features thereof), or with respect to other Aspects (or one or more features thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

The above description is intended to be illustrative, and not restrictive. For example, the above-described aspects or examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as aspects, examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A transformable cooking device includes:
a cooking surface configured for coupling with a cooker having at least one heating element, the cooking surface includes:
a planar cooking face; and
a socketed cooking face configured to support cookware having a curved surface, the socketed cooking face opposed to the planar cooking face; and
wherein the socketed cooking face includes:
a heating port extending through the cooking surface from the planar cooking surface through the socketed cooking face; and
a support ring spaced from the heating port and surrounding the heating port, the support ring configured to support the curved surface of the cookware.

2. The transformable cooking device of claim 1, wherein the heating port extends continuously across the ring.

3. The transformable cooking device of claim 1, wherein the support ring extends around the heating port.

4. The transformable cooking device of claim 1, wherein the support ring is elevated relative to a remainder of the socketed cooking face.

5. The transformable cooking device of claim 1, wherein the support ring is interconnected with the cooking surface with one or more support struts.

6. The transformable cooking device of claim 1, wherein the support ring includes a first support ring and a second support ring, and the first support ring is larger than the second support ring.

7. The transformable cooking device of claim 6, wherein the first support ring is elevated relative to the second support ring.

8. The transformable cooking device of claim 1 comprising the cooker having the at least one heating element.

9. The transformable cooking device of claim 1, wherein the cooking surface is transformable between a planar cooking configuration and a socketed cooking configuration:
in the planar cooking configuration the planar cooking face is upstanding and configured to engage cookware having a planar surface; and
in the socketed cooking configuration the socketed cooking face is upstanding and configured to engage cookware with a ring profile of the support ring complementary to cookware having the curved surface.

10. A transformable cooking device includes:
a cooking surface configured for coupling with a cooker having at least one heating element, the cooking surface includes:
a planar cooking face; and
a socketed cooking face configured to support cookware having a bowl shaped surface, the socketed cooking face opposed to the planar cooking face;
wherein the socketed cooking face includes:
a heating port extending through the cooking surface from the planar cooking surface through the socketed cooking face; and
a support ring spaced from the heating port and surrounding the heating port, the support ring configured to support the bowl shaped surface of the cookware; and
wherein the cooking surface is transformable between a planar cooking configuration and a socketed cooking configuration:
in the planar cooking configuration the planar cooking face is upstanding and configured to engage cookware; and
in the socketed cooking configuration the socketed cooking face is upstanding and the support ring supports the cookware having the bowl shaped surface with a ring profile complementary to the bowl shaped surface.

11. The transformable cooking device of claim 10, wherein the heating port extends continuously across the ring.

12. The transformable cooking device of claim 10, wherein the support ring extends around the heating port.

13. The transformable cooking device of claim 10, wherein the support ring is elevated relative to a remainder of the socketed cooking face.

14. The transformable cooking device of claim 10, wherein the support ring is interconnected with the cooking surface with one or more support struts spaced from the heating port.

15. The transformable cooking device of claim 10, wherein the support ring includes a first support ring and a second support ring, and the first support ring is larger than the second support ring.

16. The transformable cooking device of claim 15, wherein the first support ring is elevated relative to the second support ring.

17. The transformable cooking device of claim 10 comprising the cooker having the at least one heating element.
